(19) United States
(12) Patent Application Publication
(10) Pub. No.: US 2017/0049040 A1
(43) Pub. Date: Feb. 23, 2017

(54) PLANTER WITH SEED DELIVERY APPARATUS

(71) Applicant: Kinze Manufacturing, Inc., Williamsburg, IA (US)

(72) Inventor: Jon Kinzenbaw, Williamsburg, IA (US)

(21) Appl. No.: 15/241,535

(22) Filed: Aug. 19, 2016

Related U.S. Application Data
(60) Provisional application No. 62/207,651, filed on Aug. 20, 2015.

(51) Int. Cl. A01C 7/20; A01C 7/04

(52) U.S. Cl. CPC A01C 7/206; A01C 7/04

(57) ABSTRACT

An agricultural implement is provided that includes a number of row units. The row units include one or more seed meters for receiving, singulating, and dispensing seed to the ground such that preferred spacing of subsequent seed is attained. A seed delivery system is included to aid in transporting the seed from the seed meter to the ground in a controlled manner to mitigate skips and to aid in controlling the spacing of the seeds, which can be based upon the ground speed of the implement as it moves through the field. The ground speed can be mechanically transferred to the seed delivery system. The seed dispensing system can control the transport of the seed to a furrow in the field such that the seed can experience zero or near zero relative velocity so that the seed will have little to no movement once positioned in the furrow.

### CROSS-REFERENCE TO RELATED APPLICATIONS

This application claims priority under 35 U.S.C. §119 to Provisional Application Ser. No. 62/207,651, filed on Aug. 20, 2015, the contents of which are hereby incorporated by reference in its entirety.

### FIELD OF THE INVENTION

The present invention relates generally to agricultural implements. More particularly, but not exclusively, the invention relates to an agricultural planter with a seed delivery apparatus for delivering seed from a metering system of a row unit to a furrow created in the ground.

### BACKGROUND OF THE INVENTION

An agricultural row crop planter is a machine built for distributing seed into the ground. The row crop planter generally includes a horizontal toolbar fixed to a hitch assembly for towing behind a tractor. Row units are mounted to the toolbar. In different configurations, seed may be stored at individual hoppers on each row unit, or it may be maintained in a central hopper and delivered to the row units on an as needed basis. The row units include ground-working tools for opening and closing a seed furrow, and a seed metering system for distributing seed to the seed furrow.

In its most basic form, the seed meter includes a housing and a seed disc. The housing is constructed such that it creates a reservoir to hold a seed pool. The seed disc resides within the housing and rotates about a generally horizontal central axis. As the seed disc rotates, it passes through the seed pool where it picks up individual seeds. The seeds are subsequently dispensed into a seed chute where they drop into the seed furrow.

Seed spacing in the seed furrow is controlled by varying the rotational speed of the seed disc. Most commonly, seed disc rotation is driven by connection to a common driveshaft. The driveshaft runs horizontally along the length of the toolbar to connect to each row unit, and is driven by a single motor or a ground contact wheel. In this configuration, the planting rate can be adjusted for all row units uniformly by adjusting the rotational speed of the common drive shaft. This can be a tedious task, and an operator is unlikely to adjust the gear ratio as often as necessary to maximize yields. Generally, an optimal overall rate for a given acreage will be selected prior to planting and will be maintained at that rate regardless of soil conditions. Whether using a mechanical, air, or vacuum style seed disc, the seed disc is installed inside of the seed meter using independent fasteners and requires the use of tools to facilitate changing the disc. For example, if a farmer uses the same planter to plant corn and soybeans, he would use a different disc for the respective seed types.

More recently, planters have been designed to provide for independent driving of each of the seed discs in each seed meter. The meters include a motor, such as an electric motor, that is attached to the meter. The output shaft extends from the motor and into the meter such that a portion of the shaft is operatively connected to the seed disc. Therefore, the motor will operate to rotate the seed disc. These planters rely on a Global Positioning System (GPS), which is not always as accurate as desired.

The most common seed delivery system for delivering seed from the seed disc to the furrow may be categorized as a gravity drop system. In the case of the gravity drop system, a seed tube has an inlet end, which is positioned below the seed metering system. The singulated seeds from the seed metering system drop into the seed tube and fall via gravitational force from a discharge end thereof into the seed trench. Monitoring systems are commonly used to monitor the operation of the planter. Such systems typically employ a seed sensor attached to each seed tube to detect the passage of seed therethrough.

However, such a gravity system can affect the seed spacing of the planter. For example, as the spacing of the speed is dependent on the rotational velocity of the seed disc and the gravitational constant, interruptions, forces, or other occurrences acting on the seed can greatly affect the spacing. For example, if the seed bumps against a wall of the seed tube on the way to the furrow; this can cause a delay or a non-vertical fall of the seed. If a preceding or following seed does not experience the same interruption, the seeds could be spaced too close or far from one another.

Furthermore, as the speed of planting increases, this causes additional problems. Drawing a planting implement through the field at faster speeds increases the speed of deposited seeds relative to the ground, causing seeds to roll and bounce upon landing in the trench or furrow and resulting in inconsistent plant spacing. The adverse agronomic effects of poor seed placement and inconsistent plant spacing are well known in the art.

Therefore, there is a need in the art for an agricultural planting implement that includes a seed delivery apparatus that aids in delivering seed from a singulating seed meter to a furrow or trench in the field, such that the spacing of adjacent seed is more consistent to increase the yield obtained of the end crop.

### SUMMARY OF THE INVENTION

Therefore, it is a principal object, feature, and/or advantage of the present invention to overcome the deficiencies in the art.

It is another object, feature, and/or advantage of the present invention to provide an agricultural planter with a seed delivery apparatus to provide consistent spacing between adjacent seed.

It is yet another object, feature, and/or advantage of the present invention to provide a seed delivery apparatus, mechanism, and/or assembly that will deliver a seed from a seed metering device to the field.

It is still another object, feature, and/or advantage of the present invention to provide a seed delivery apparatus that will provide optimized spacing in a seed furrow.

It is a further object, feature, and/or advantage of the present invention to provide a seed delivery apparatus that will allow for planting with increased speed.

It is still a further object, feature, and/or advantage of the present invention to provide a seed delivery apparatus that provides for seed spacing that will not be influenced by abrupt forces during travel.

It is yet another object, feature, and/or advantage of the present invention to provide a controlled delivery of seed from a seed meter to the ground wherein a seed experiences near zero relative velocity during drop, regardless of the velocity of the planter.

These and/or other objects, features, and advantages of the present invention will be apparent to those skilled in the art. The present invention is not to be limited to or by these objects, features and advantages. No single embodiment need provide each and every object, feature, or advantage.

The present invention relates to various seed delivery systems for providing a desired, equidistant spacing of seed in a field, regardless of the speed of travel of an agricultural planter. Some aspects of the systems can include that the delivery of the seed from a seed meter to a trench or furrow in the ground will not be influenced by factors such as external forces, including the free fall of gravity. Furthermore, at least some of the systems provide setups that provide that the seed will be release with substantially zero relative velocity such that the seed will land softly within a trench or furrow, and will have little to no bounce therein, which will aid in the correct spacing of the seed.

### BRIEF DESCRIPTION OF THE DRAWINGS

FIG. 1 is a perspective view of an agricultural planting implement.

FIG. 2 is a side elevation view of a row unit for use with a planting implement.

FIG. 3 is a side elevation view of another row unit showing a seed meter and seed tube of row unit for use with a planting implement.

FIG. 4 is a side elevation view of a row unit according to some aspects of the invention.

FIG. 5 is a top view of the row unit of FIG. 4.

FIG. 6 is a side, sectional view of the seed meter and seed delivery apparatus of FIGS. 4 and 5.

FIG. 7 is a perspective view of an exemplary seed delivery apparatus for use with a row unit according to aspects the invention.

FIG. 8 is a top view of an exemplary seed delivery apparatus for use with the row unit according to aspects the invention.

FIG. 9 is a rear view of an exemplary seed delivery apparatus for use with the row unit according to aspects the invention.

FIG. 10 is a side view of an exemplary seed delivery apparatus for use with the row unit according to aspects the invention.

FIG. 11 is a perspective view of an exemplary seed delivery apparatus according to additional aspects of the invention.

FIG. 12 is a top view of an exemplary seed delivery apparatus of FIG. 11.

FIG. 13 is a rear view of an exemplary seed delivery apparatus of FIG. 11.

FIG. 14 is aside view of an exemplary seed delivery apparatus of FIG. 11.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

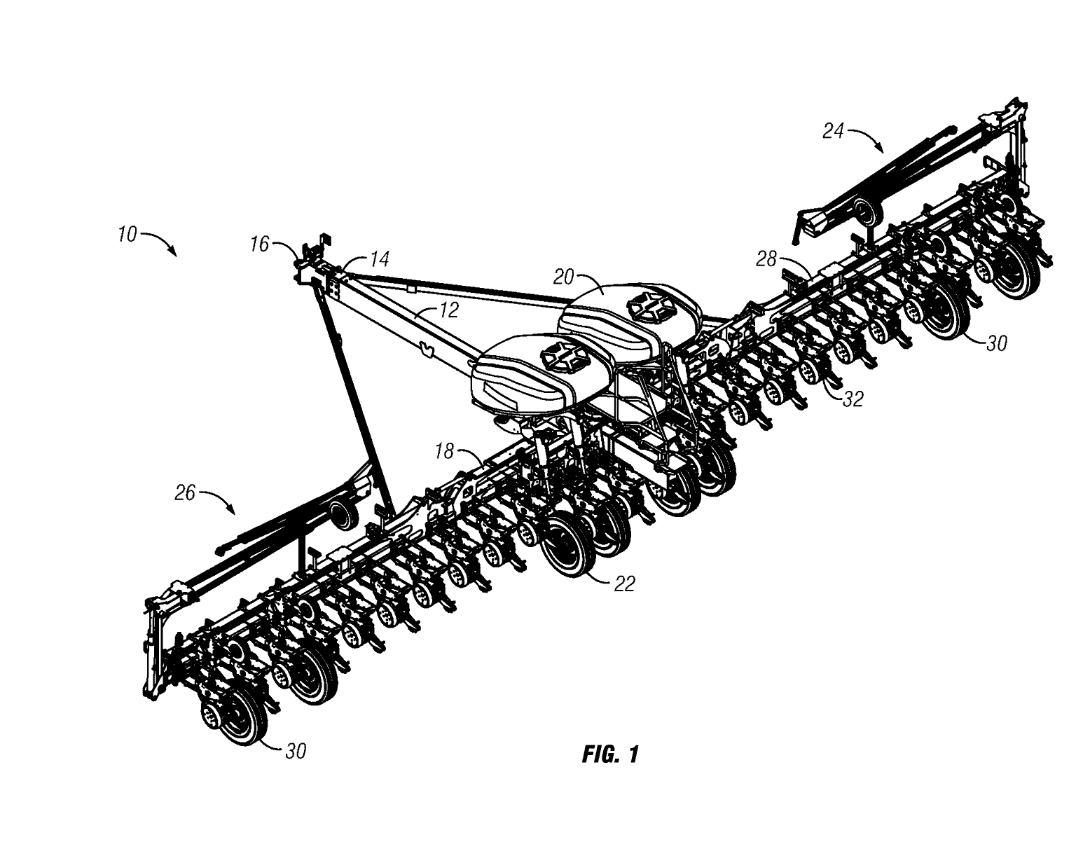

FIG. 1 shows an agricultural implement 10, in this case, an agricultural planter. The planter 10 is usually attached to and pulled by a tractor. However, it should be appreciated that other equipment and/or vehicles may move the implement 10. For purposes of the present disclosure, the implement 10 will be referred to as a planter.

The planter 10 includes a tongue 12 having a first end 14 and an opposite second end (not shown). The tongue 12 includes a hitch 16 at the first end 14, with the hitch 16 being connected to the tractor. At the opposite end of the tongue 12 is a central tool bar 18. The tongue 12 may be a telescoping tongue with components capable of being inserted into one another such that the implement 10 is a front folding style implement. However, the present invention is not to be limited to such front folding style implements and is to include any such implement for use in the agricultural industry.

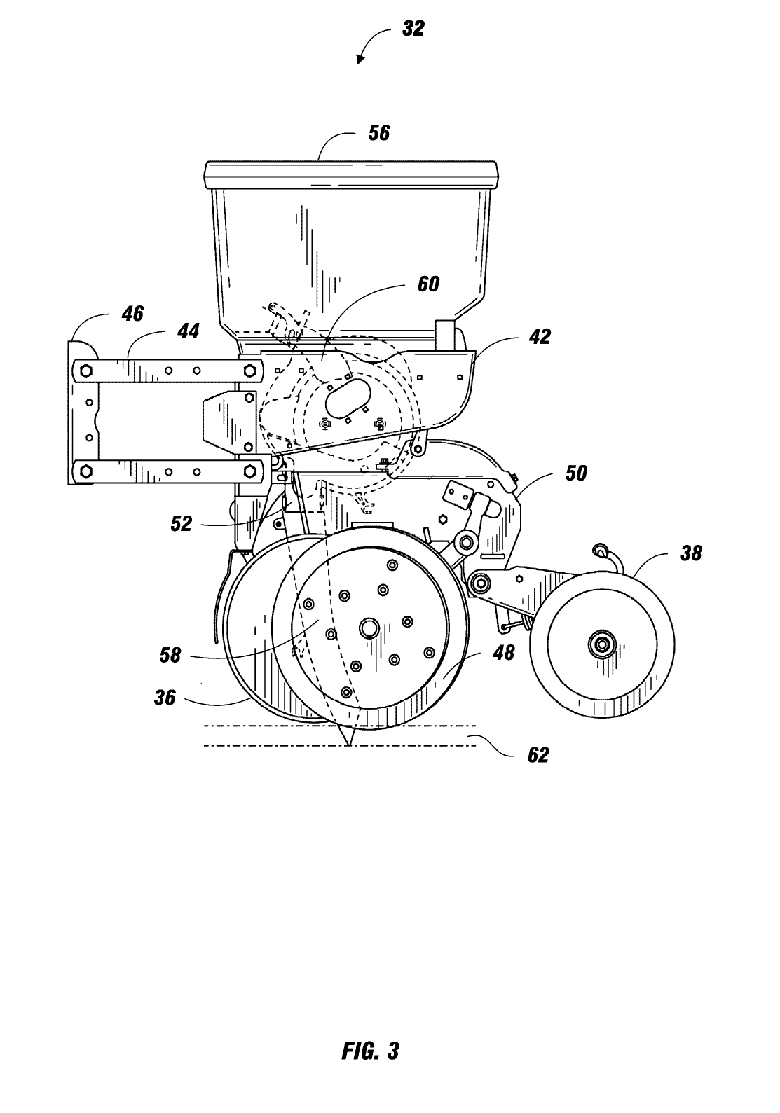

As shown in FIG. 1, central hoppers 20 are positioned at the central toolbar 18. The hoppers 20 are configured to store seed, fertilizer, insecticide, or other types of material for use in farming. The hoppers 20 may both contain the same material, or could contain separate materials. The use of the central hoppers 20 allows for a large amount of material to be added and stored at a centralized location. However, the invention also contemplates the use of one or more hoppers positioned at each of the row units 32 for providing seed to be planted at the row units, as is shown in FIG. 3. When central hoppers 20 are used at the central toolbar 18, it should be appreciated that the central hoppers will be in fluid communication with each of the row units 32. This can be done by use of separate hoses to each of the row units, or fewer hoses that include splitters, wherein the hose is split to provide seed or other material to more than one row unit. Also connected to the central toolbar is a plurality of central wheels, which may be known as transport wheels 22 extending generally downwardly from the central toolbar 18. The wheels 22 contact the ground and support the central hoppers 20. The wheels stabilize the implement 10 and are the wheels that contact the ground when in a working position or a transport position, e.g., if the implement 10 is a front folding implement such that the wings 24, 26 are folded forward with wing wheels 30 not contacting the ground.

Extending generally from both sides of the toolbar 18 are first and second wings 24, 26. The wings 24, 26 are generally identical and mirror images of one another. Therefore, only one wing will be described with the understanding that the other wing will be generally the same configuration. The first wing 24 includes a bar 28. Mounted to the bar 28 are a plurality of row units 32, as well as a plurality of wheels 30. The wheels 30 are configured to contact the ground. The row units 32 may be seeders, fertilizers, insecticide sprayers, or other dispensers, discs, or plows. The wings 24, 26 may also include at least one fold cylinder and a down force cylinder. It is further contemplated that multiple down force cylinders be used with an implement having more sections. The fold cylinder(s) is configured to fold the wings to a position wherein the first and second wings 24, 26 are generally adjacent the tongue 12 of the implement 10.

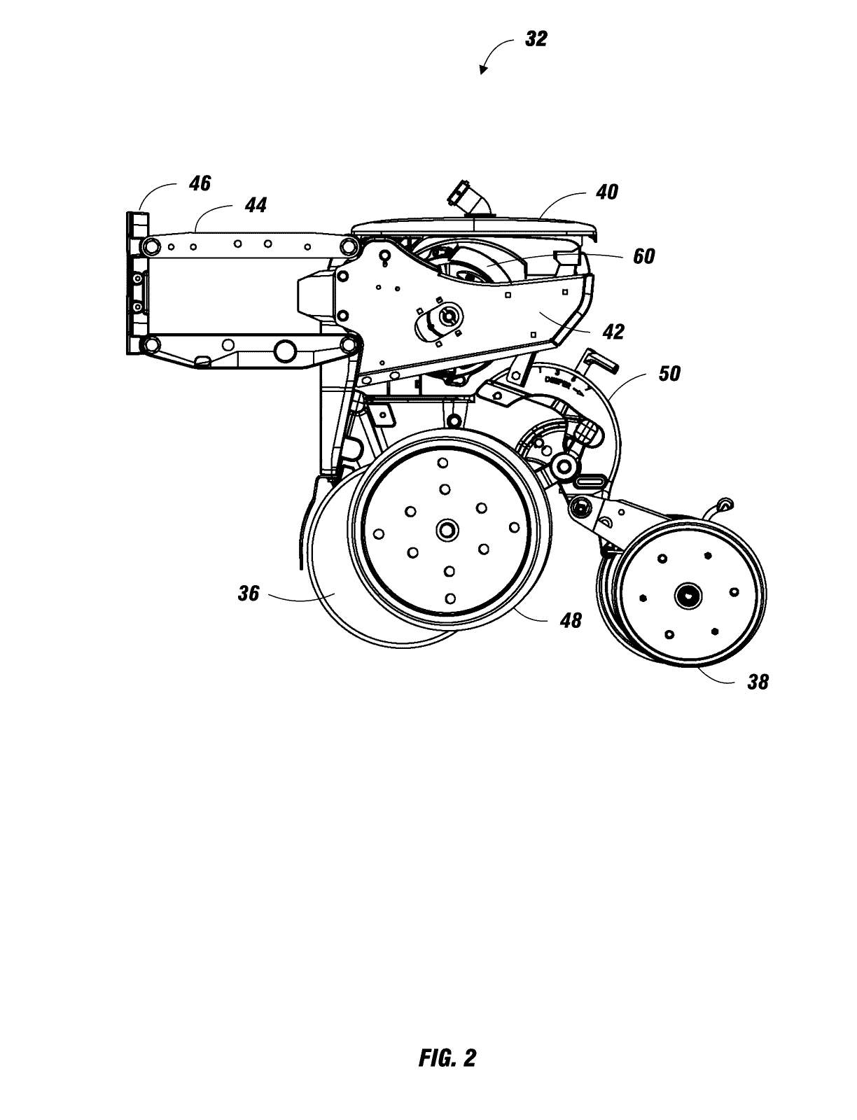

FIG. 2 is a side elevation view of a typical row unit 32, and more specifically, a seeder including a singulating seed meter 34. The row unit 32 includes a seed meter 34, furrow opener 36, seed meter lid 40, and furrow closer 38. Other aspects of the row unit 32 shown in FIG. 3 include a frame 42, linkage 44, mount 46 for mounting to the planter 10, gauge wheels 48, and depth control mechanism 50. The gauge wheels 48 and depth control mechanism 50 work together to control the depth of the furrow or trench created by the opener 36. Furthermore, the row hopper 56 is connected to a seed supply, such as the central hoppers 20 via air seed delivery system, which can provide the seed meter 34 of each row unit 32 with seed to be planted. The seed meter can be generally any air or mechanical meter capable of singulating seed and delivering seed from the meter 34 via a seed chute 52 extending therefrom.

FIG. 3 is a side elevation view of another typical row unit 32. The row unit 32 shown in FIG. 3 includes a row hopper 56, which is capable of storing seed or other granular or particulate matter to be dispensed by the row unit 32. Other components of the row unit 32 shown in FIG. 3 are similar to those shown in the embodiment of FIG. 2. As shown in generally dashed lines in FIG. 3, is a seed meter 34 with a seed tube 58 attached thereto. The seed meter 34 may be an air seed meter or a mechanical seed meter, such as a finger brush seed meter. The seed meter 34 includes a seed disc 54 rotating within the housing thereof. The seed disc 54 includes a plurality of radially spaced seed apertures comprising a seed path. The seed apertures of the seed path pass through a pool of seed where the seed is temporarily attached or affixed to the seed apertures. The seed disc with the attached thereto continues rotation through a singulating mechanism, otherwise known as a seed singulator. A seed singulator 60 includes one or more protrusions positioned on opposite sides of the seed path to make sure that a single seed is attached to each single seed aperture. Thus, the seed singulator prevents or mitigates the chance of doubles being planted.

Furthermore, it should be appreciated that the seed meter can be electrically driven or ground driven. Electrically driven seed meters allow for more direct control of the speed of seed dispensing on a row to row basis. However, ground driven meters, where a transfer member is connected to wheels, axles, or the like, also allow for independent and variable singulation and dispensing rates of seed meters at row units based upon the speed of the individual row unit traveling. This is important, especially when turning, as some row units will have a greater ground speed than others, making it necessary to control the planting rates at the variable speed locations to maintain proper seed spacing.

After passing through the seed singulating mechanism 60, the seed attached to the seed disc 54 continues rotation until it reaches a release point. Such a release point may coincide with a zero pressure differential location or an ejector mechanism within the seed housing of the seed meter 34. Generally located adjacent the release point for the seed meter 34 is a seed chute 52 extending as part of the housing of seed meters 34. The seed chute 52 is configured to begin directing the seed from the seed meter towards the furrow 62 in the ground. Further shown in FIG. 3 is a seed tube 58 separate from and attached to the seed chute 52. The seed tube 58 is a mechanism, which is known in the art to further provide a path for the seed 64 to travel after being released from the seed disc 54. Therefore, a plurality of seed 64 is passing through the seed tube 58 and into the furrow 62. The rotation of the seed disc 54 within the seed meter 34 will control the spacing of the seed 64 within the furrow 62. For example, matching the rotational velocity of the seed disc 34 to the traveling velocity of the tractor and planter 10 will provide for seed being evenly spaced throughout a field. However, as the seed is being passed through the seed tube 58, it may interact with the walls of the seed tube 54, which can disrupt the falling speed of the seed 64 as it passes through the seed tube. Such a disruption can cause the seed to not fall at a constant speed. This can create uneven spacing of seed, as some seed will bounce off the walls, and others will not. Therefore, the seeds may be too close or too far from one another within the furrow 62. Such an uneven spacing can cause a seed to battle over nutrients and water, or possibly be planted too far apart from one another. All of these issues can create a lower than desired yield obtained by a farmer.

Therefore, the embodiments of the present invention will provide for improvements to the prior art seed delivery systems, which may be seed tubes 58, such that equal distant spacing of the seed 64 and furrow 62 is obtained. The embodiment herein shown and described will provide for a more consistent and even spacing of the seed, regardless of the planter velocity of travel, as well as without regard to external forces (gravity, obstructions, elevation, etc.) acting on the row units 32 of the planter 10. The seed delivery system of the present invention will thus increase the yield obtained by a farmer by providing a higher consistency of seed spacing, such that the seeds will receive their required nutrients and such that the full area of the field being planted will be utilized by the planting of the seed.

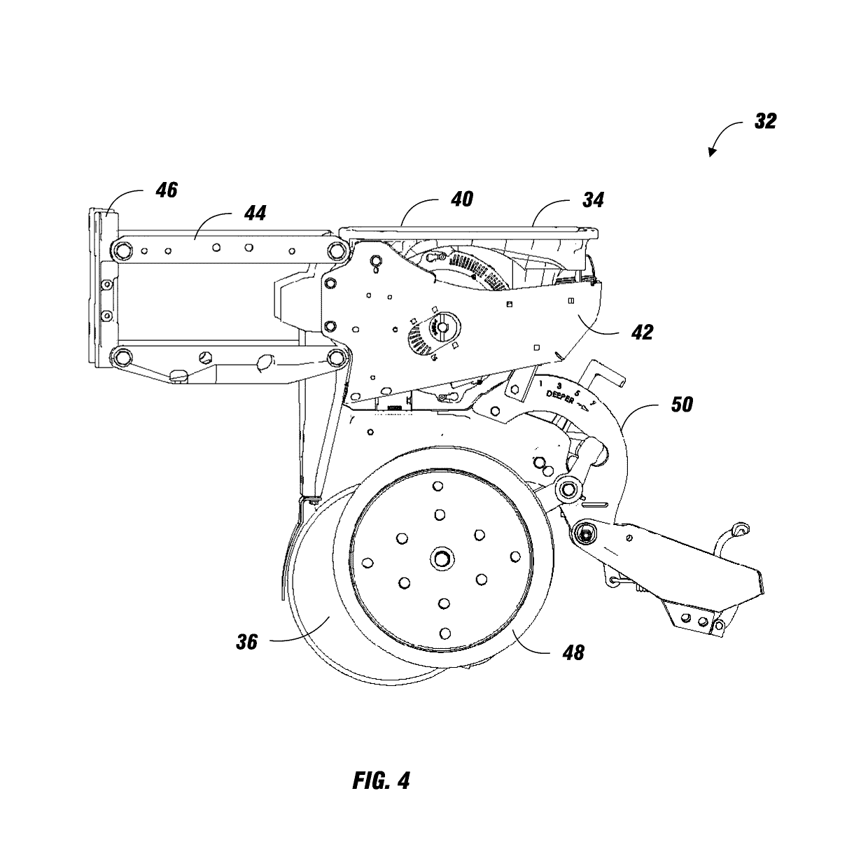

FIG. 4 is a side elevation view of a row unit 32, and more specifically, a seeder including a singulating seed meter 34 for use with the present invention. The row unit 32 includes a seed meter 34, furrow opener 36, and seed meter lid 40. Other aspects of the row unit 32 shown in FIG. 4 include a frame 42, linkage 44, mount 46 for mounting to the planter 10, gauge wheels 48 for controlling the depth of furrow, and depth control mechanism 50. The gauge wheels 48 and depth control mechanism 50 work together to control the depth of the furrow or trench created by the opener 36. Furthermore, the seed meter lid 40 is connected to a seed supply, such as the central hoppers 20 via air seed delivery system, which can provide the seed meter 34 of each row unit 32 with seed to be planted. The seed meter can be generally any air or mechanical meter capable of singulating seed and delivering seed from the meter 34 via a seed chute 52 extending therefrom.

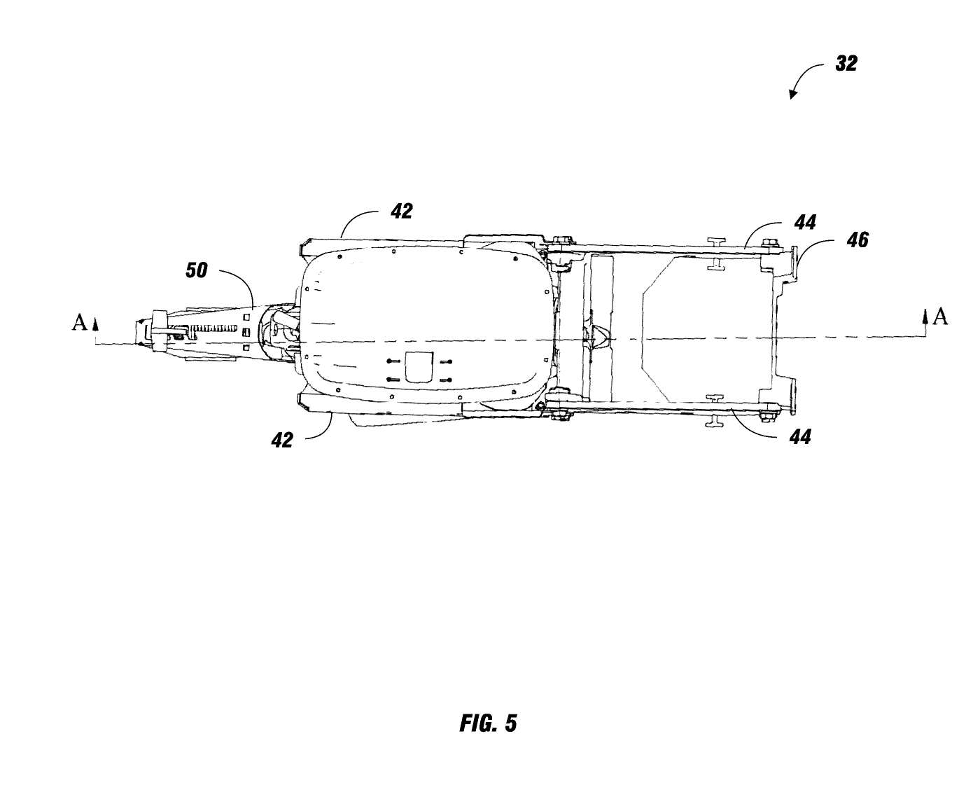

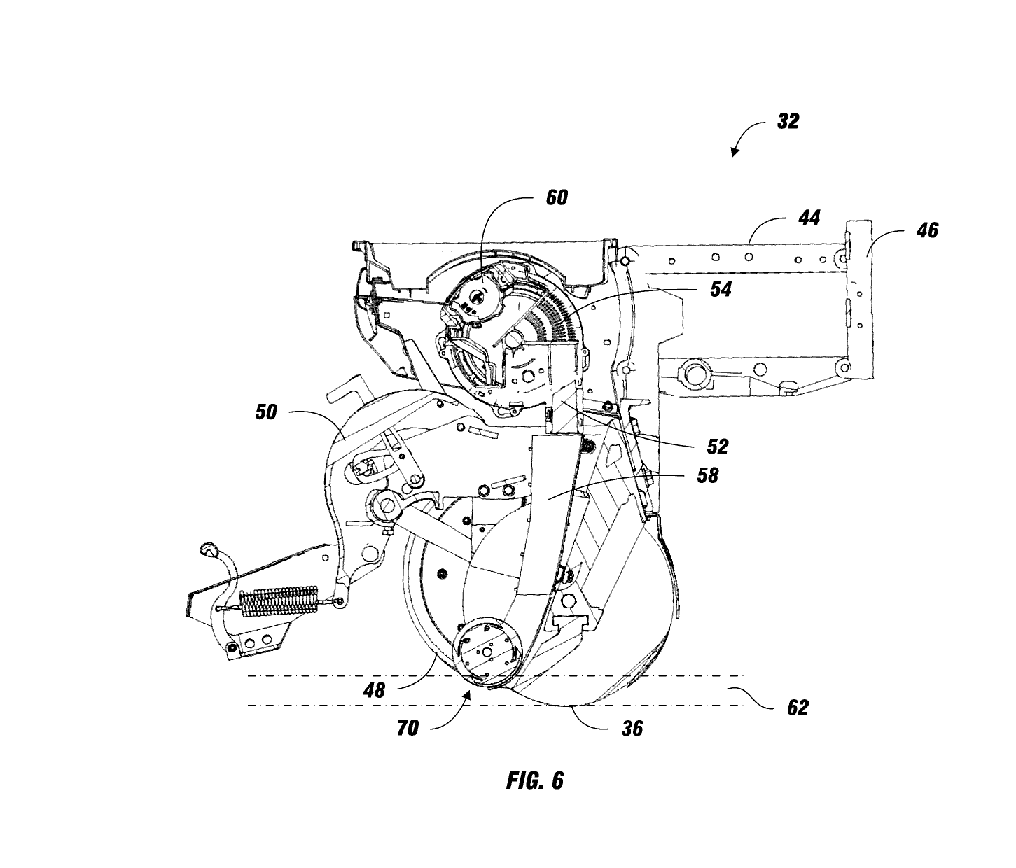

FIG. 5 is a top view of a row unit 32, such as that shown in FIG. 4, according to exemplary aspects of the present invention. FIG. 6 is section view A-A of a row unit 32, as shown in FIG. 5. The row unit 32 includes a seed meter 34, seed meter lid 40, seed chute 52, seed tube 58, and seed dispensing assembly comprising a catch wheel assembly 70. Other aspects of the row unit 32 shown in FIG. 6 include a linkage 44, a mount 46 for mounting to the planter 10, a furrow opener 36, gauge wheels 48, and a depth control mechanism 50. The gauge wheels 48 and depth control mechanism 50 work together to control the depth of the furrow or trench created by the opener 36. Furthermore, seed meter lid 40 is connected to a seed supply, such as the central hoppers 20 via air seed delivery system, which can provide the seed meter 34 of each row unit 32 with seed to be planted. Additionally, the row unit 32 may include hoppers attached to the row unit to provide seed and/or fertilizer. The seed meter can be generally any air or mechanical meter capable of singulating seed and delivering seed from the meter 34 via a seed chute 52 extending therefrom. The seed meter 34 may be an air seed meter or a mechanical seed meter, such as a finger brush seed meter. The seed meter 34 includes a seed disc 54 rotating within the housing thereof. The seed disc 54 includes a plurality of radially spaced seed apertures comprising a seed path. The seed apertures of the seed path pass through a pool of seed where the seed is temporarily attached or affixed to the seed apertures. The seed disc with the attached thereto continues rotation through a singulating mechanism, otherwise known as a seed singulator. A seed singulator 60 can include one or more protrusions or brushes positioned on opposite sides of the seed path to make sure that a single seed is attached to each single seed aperture. Thus, the seed singulator prevents or mitigates the chance of doubles being planted.

The rotation of the seed disc 54 within the seed meter 34 will control the spacing of the seed 64 within the furrow 62. For example, matching the rotational velocity of the seed disc 54 to the traveling velocity of the tractor and planter 10 will provide for seed being evenly spaced throughout a field.

Therefore, the embodiments of the present invention will provide for improvements to the prior art seed delivery systems, which may be seed tubes 58, such that equal distant spacing of the seed 64 and furrow 62 is obtained. The embodiment herein shown and described will provide for a more consistent and even spacing of the seed, regardless of the planter velocity of travel, as well as without regard to external forces (gravity, obstructions, elevation, slope, etc.) acting on the row units 32 of the planter 10. The systems disclosed herein can also be utilized without GPS or other systems that attempt to determine the ground speed of the planter and/or row units attached thereto. The various seed delivery systems of the present invention will thus increase the yield obtained by a farmer by providing a higher consistency of seed spacing, such that the seeds will receive their required nutrients and such that the full area of the field being planted will be utilized by the planting of the seed.

After passing through the seed singulating mechanism 60, the seed attached to the seed disc 54 continues until it reaches a release point. Such a release point may coincide with a zero pressure differential location or an ejector mechanism within the seed housing of the seed meter 34. Generally located adjacent the release point for the seed meter 34 is a seed chute 52 extending as part of the housing of the seed meters 34. The seed chute 52 is configured to begin directing the seed from the seed meter towards the furrow 62 in the ground. Further shown in FIG. 6 is a seed delivery system comprising a catch wheel assembly 70, as will be understood.

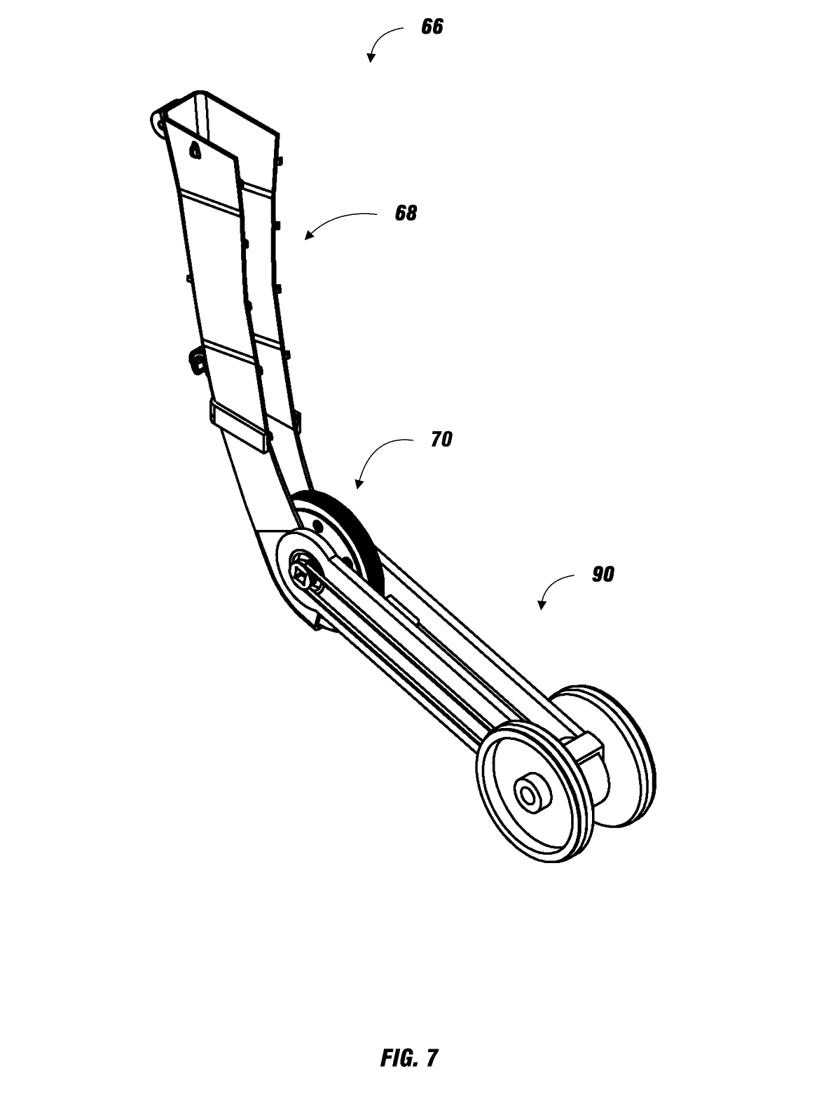

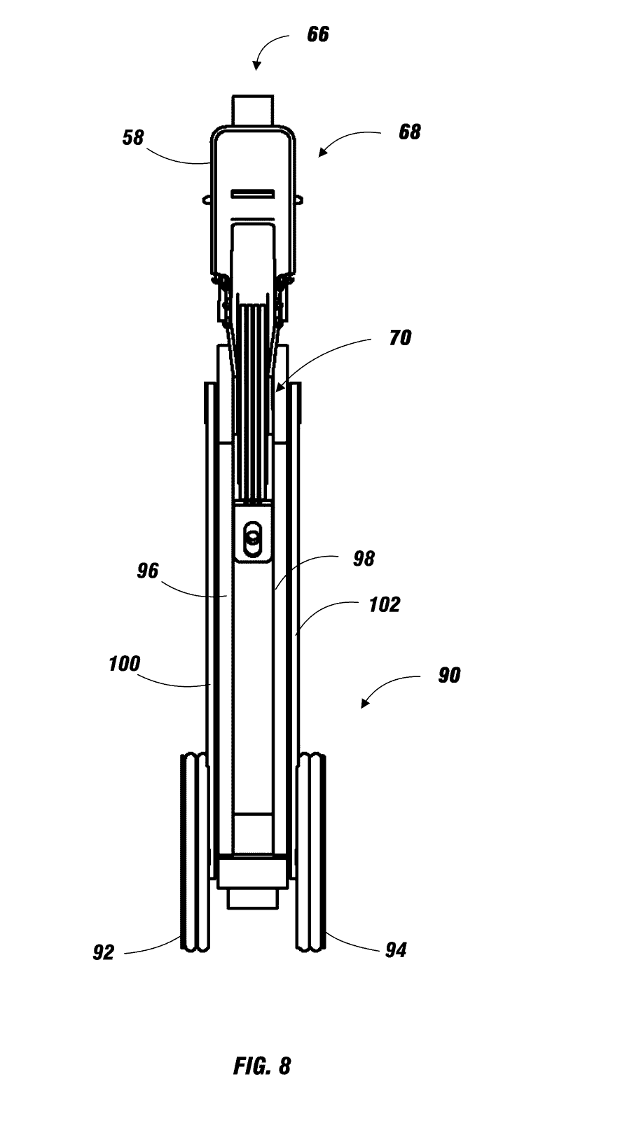

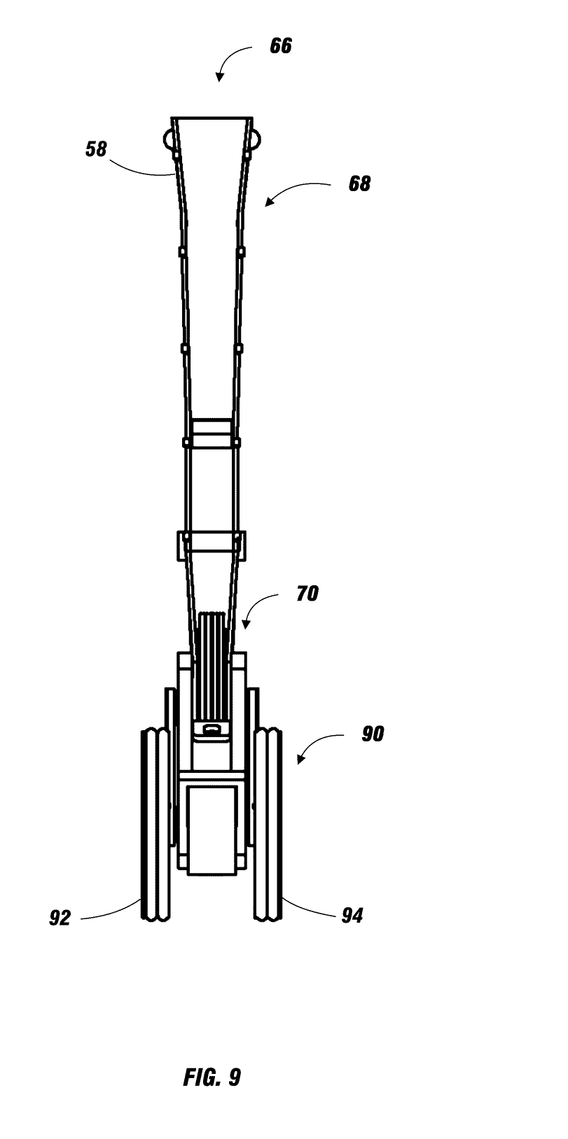

FIG. 7 shows the embodiment of a seed delivery or dispensing system 66 according to aspects of the invention. Such as system can be included and used with a row unit as has been shown and described. The seed delivery system 66 shown in FIG. 7 includes a seed placement assembly 68, a catch wheel assembly 70, and a drive mechanism assembly 90. As shown in FIGS. 8-10, the drive mechanism assembly 90 includes trailing arms 96 and 98. The drive mechanism assembly 90 further includes trailing wheels 92 and 94, which drive catch wheel assembly 70 via one or more transfer members, such as drive belts 100 and 102. However, it should be appreciated that the transfer members can comprise additional materials/configurations, including but not limited to, chains, belts, gears, fluid, linkages, and/or some combination thereof. Still further, it is contemplated that the catch wheel is directly driven off of the ground. For example, a bottom portion of the catch wheel could be in contact with the ground, such as in the furrow, wherein the rotational velocity will be directly transferred to the catch wheel. This would also lower the delivery point of the catch wheel to be at or near the bottom of the furrow, which will also help to reduce bounce and/or roll of the seed within the furrow. Trailing wheels 92 and 94 may comprise metals such as steel or aluminum, rubber, synthetic compounds, or any combination thereof. The trailing wheels may also comprise embossed treads. Drives belts 100 and 102 may also be chains, or any fluid. Trailing wheels 92 and 94 engage and maintain contact with a field or other ground 114 and attached to the seed tube 58 via pivot point 112. The pivot point 112 can be biased utilizing a spring (not shown) or a compressible fluid (not shown). The pivoting connection allows for the wheels 92, 94 to traverse over varying elevations, obstructions, and any other change in the field.

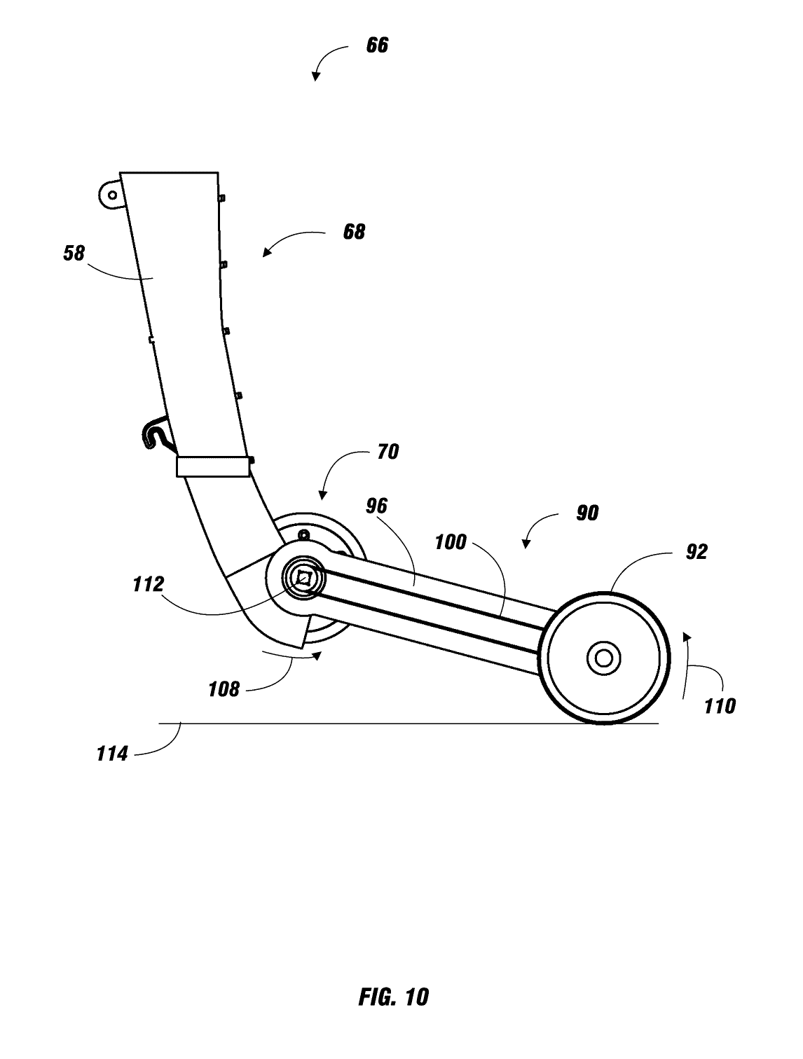

As the row planter 10 moves through the field, the trailing wheels 92 and 94 rotate as indicated by the arrow 110, shown in FIG. 10. The trailing wheels 92 and 94 cause the drive belts 100 and 102 to move and engage the catch wheel assembly 70. The catch wheel assembly rotates as indicated by the arrow 108. Thus, the catch wheel 70 will dispense each seed at the actual speed of the row unit using only contact drive via the trailing wheels 92 and 94. This eliminates the need to calculate the speed of the planter 10 and thus utilize electronic adjustments because the trailing wheels 92 and 94 are rotated along with the actual the speed a row unit of the planter 10. This is advantageous, as the ground driven system allows for automatic turning compensation, i.e., as the planter turns, some row units will be moving at higher speeds while others may not be moving at all. The ground driven aspects of the system allow for the dispensing of seed matching the turning speeds of the row units to maintain the desired spacing of dispensed seed. This would eliminate GPS lag, which can have a delay of up to a second or more. The system would thus know exactly when the planter has started or stopped.

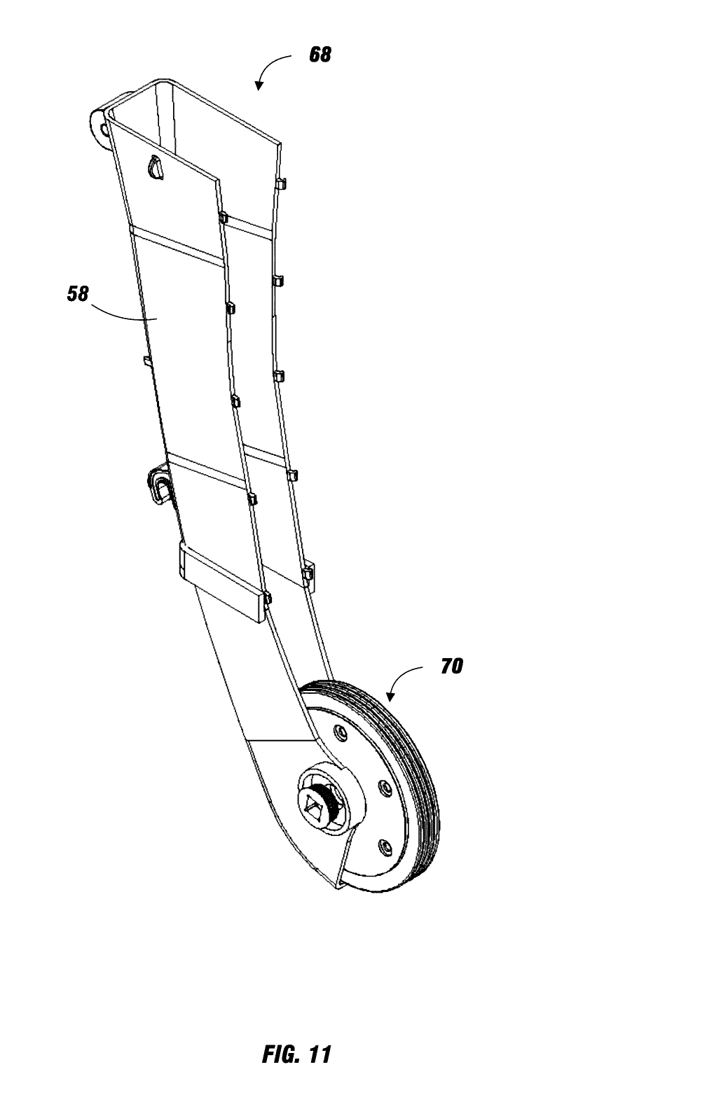

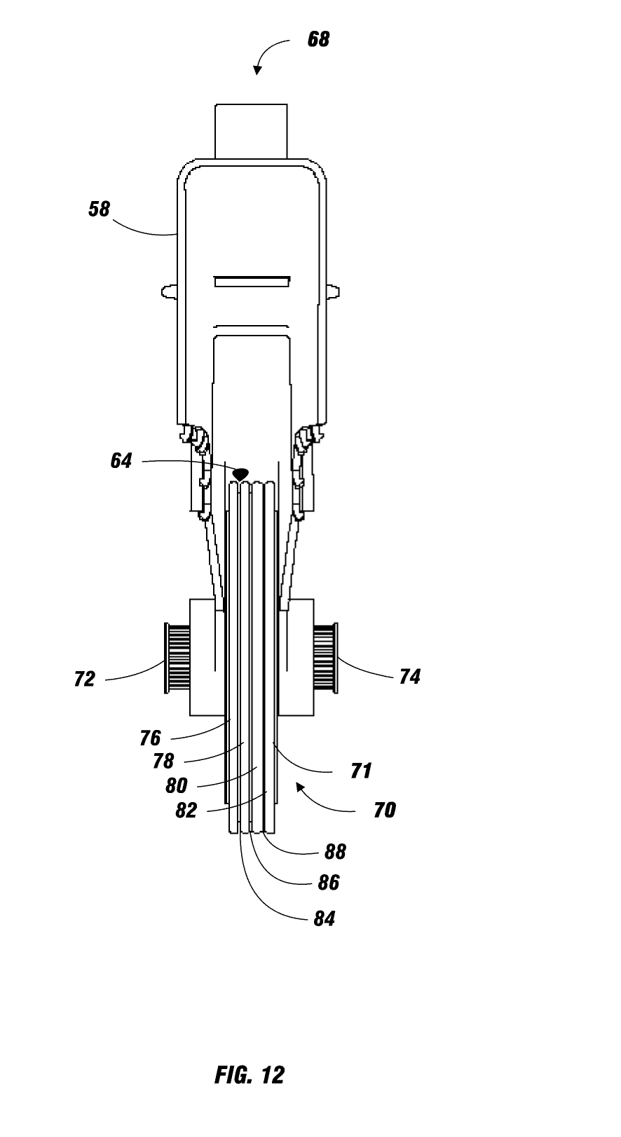

The seed placement assembly 68 shown in FIG. 11 includes a seed tube 58 and a catch wheel assembly 70. As shown in FIGS. 12-14, a plurality of seed 64A-G is passing through the seed tube 58 and into the furrow 62. Extending from seed meter 34 is a seed chute 52, which is attached to seed tube 58. It is contemplated that the seed delivery system 66 shown in FIG. 7 may be positioned generally adjacent or close to the ground of the field. Therefore, a seed tube 58 can still be utilized to provide an enclosed member for the seed to pass after being released from the seed disc 54 of the seed meter 34. However, the seed chute 58 can be sized with a diameter such that the seed may not pass through a seed a seed tube 58, such that it will not bounce off the walls of said seed tube 58.

The catch wheel assembly includes a wheel 71 housed within the lower housing or portion of the seed tube 58 and is rotatably attached thereto such that the wheel 71 is able to rotate therein. The wheel 71 may comprise a pliable material, such as foam, rubber, or other compressible or otherwise deformable materials. The diameter of the wheel 71 is slightly less than inside width of the lower housing of seed tube 58 such that the wheel is able to rotate within the lower housing of seed tube 58 with minimal distance between the outer edge of the wheel 71 and the interior of the wall of the lower housing of seed tube 58. This will provide for controlled movement of the seed by the wheel 71 as the wheel rotates with the seed between the wheel and the wall of the tube 58. The drive belts 100 and 102 engage the catch wheel 71 drive interfaces 72 and 74 between an output shaft (not shown) of the axis of the wheel 71 to provide rotation thereto.

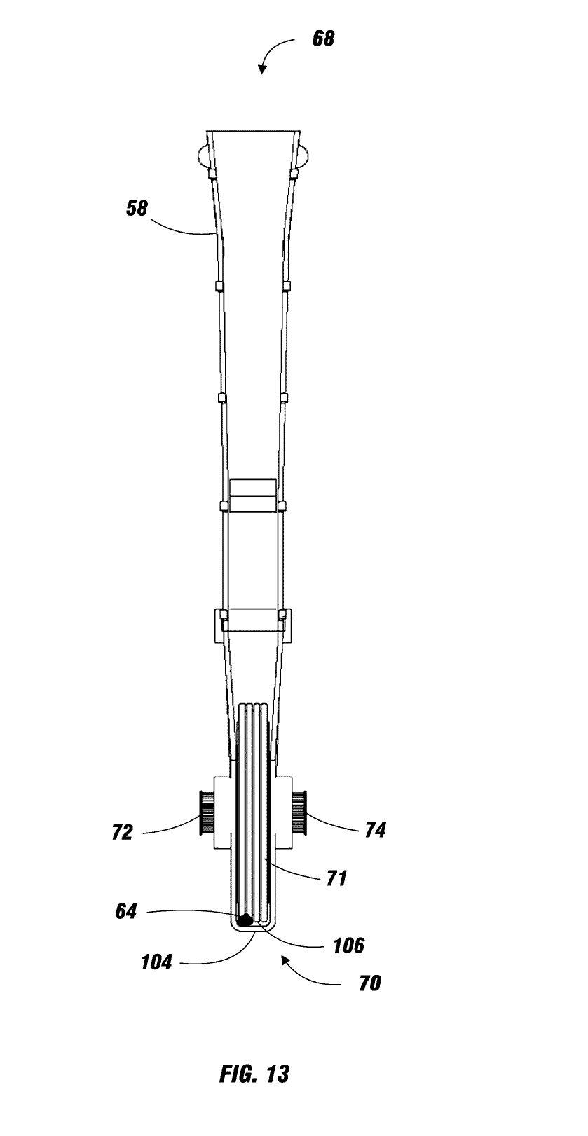

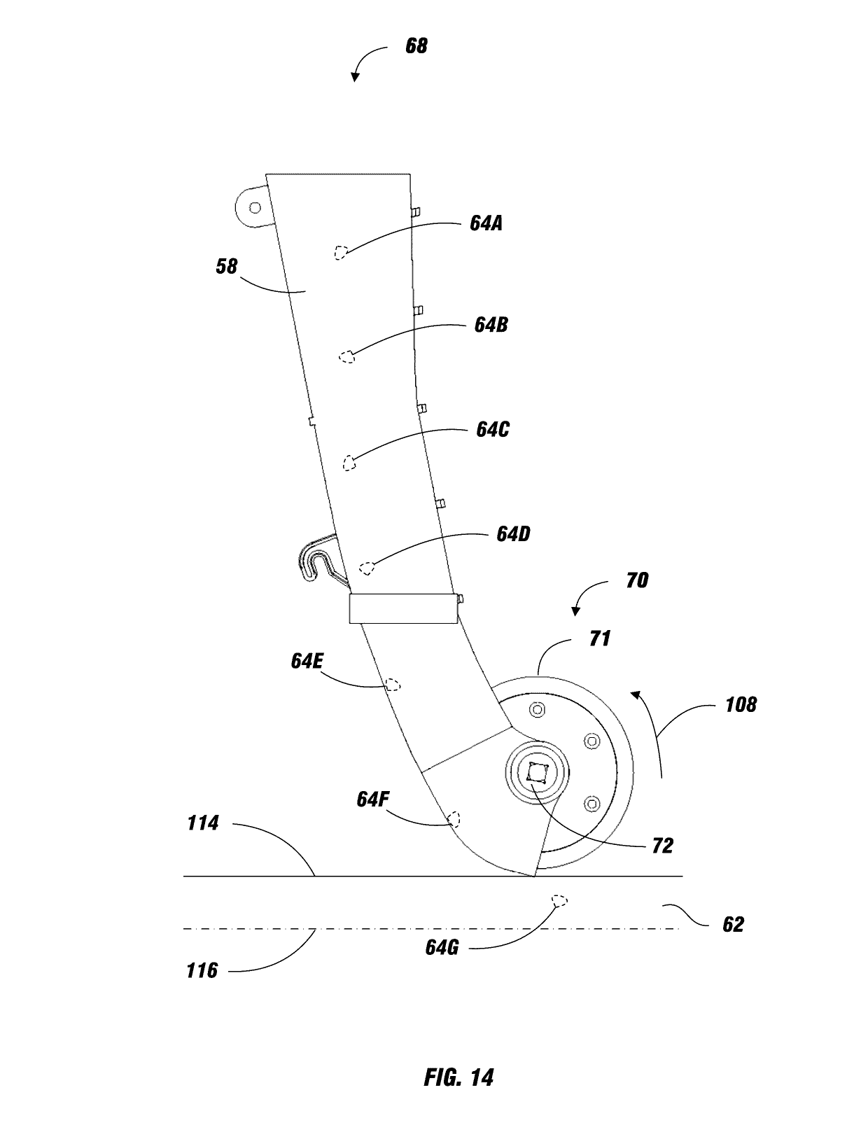

In operation, seed is released from the seed disc 54 of the seed meter 34 and allowed to pass through the tube 58. Seed will then continue downward towards a pinch point between the outer portion of the wheel 71 and the interior of the wall of the lower housing of the seed tube 58. Such a pinch point is shown as numeral 104 in FIG. 13. The pliable wheel can be partially deformed at the point of the seed to allow the seed to affix at a location on an outer profile of the wheel 71 as it rotates within the lower housing of seed tube 58. Therefore, the continued rotation of the wheel 71, shown as the arrow 108 in FIG. 14, will move the seed about the lower housing of seed tube 58 and towards a release point 104, wherein the seed will be released from the wheel 71 and deposited in the furrow 62 in the field. Thus, the seed dispensing system 66 shown in FIG. 5 provides for a system in which the seed is pinched between the wheel 71 and the interior of a wall of the lower housing of seed tube 58 to move the seed through the housing in a controlled manner such that the rotational velocity of the wheel 71 will control the spacing and delivery of the seed in a field.

The wheel 71 and lower housing of seed tube 58 may be sized such that they minimize the drop distance from the seed disc 54 to the ground, which would eliminate the length of the seed tube 58 between the release point from the seed disc and the entrance into the lower housing of seed tube 58. In addition, the invention contemplates that the wheel 71 may comprise many different sizes, which can account for different seed types, speeds of travel, or other factors that may affect the planting rate of a seed.

Advantages of the seed dispensing system 66 shown and described are numerous. For example, the rotational velocity shown by the arrow 108 of the seed tube is be matched with the ground velocity of the planter shown by the arrow 110, such that the seed will experience generally zero relative velocity at the point of release 104. Therefore, the seed will drop substantially straight from the seed tube 58 so that each seed will not bounce within the furrow. In other words, the wheel can be traveling at the same velocity as the planter as the planter moves through the field and will be adjusted automatically along with the change in velocity of the individual row unit such that a change in row unit velocity can cause a similar change in rotational velocity of the wheel 71 as the planters move, which will provide for a consistent and even spacing of the seed in the field. Stopping the rotation of the wheel 71 will stop the planting of the seed, wherein the seed will be maintained in position between the wheel and the wall of the housing, such as when the tractor is turning or otherwise in a position where seed is not to be planted. Furthermore seed dispensing system 66 can utilized in existing planters 10 as a retrofit to gain all the disclosed benefits. System 66 can also be utilized with multi-hybrid row units wherein a first seed meter and a second seed meter are mounted on the row unit.

Furthermore, variations to the invention are considered to be a part of the disclosure. For example, the drive wheels may not need be positioned rear of the seed tube, and can be positioned in front of or even attached directly to the seed tube to transfer the ground velocity of the row unit to the catch wheel of the seed delivery system. Furthermore, the drive wheel could also be connected to the seed meter or meters of a row unit to provide for the rotational velocity of the meter to match the rotation velocity of the catch wheel. In such a situation, gears or other mechanisms could be included to account for any variation in velocity due to differing diameters and/or distances. Still further, it is contemplated that the catch wheel and drive system could be used with other seed delivery members, such as belts, brushes, air tubes, or the like, to provide for the controlled dispensing of seed into a furrow.

Thus, various configurations of seed delivery systems have been shown and described. It should be appreciated that the system shown and described are for exemplary purposes, and the invention of a controlled system for delivering seed from a singulating seed meter to the ground to provide for consistent and equidistant spacing of the seed in the ground has thus been provided. It is to be contemplated that numerous variations, changes, and otherwise, which are obvious to those skilled in the art are to be considered part of the present invention.

What is claimed is:

1. A row unit for use with an agricultural implement, comprising:
at least one seed meter comprising a seed disc and a seed exit; and
a seed delivery system for transporting seed from the seed meter to a furrow in the ground, the seed delivery system comprising:
a seed tube operatively connected to the seed meter;
a resilient member positioned near a bottom of the seed tube for transporting seed at least partially between the seed tube and the resilient member to discharge the seed towards the furrow; and
a ground contact drive operatively connected to resilient member and configured to translate the ground speed of the row unit to a rotational velocity for the resilient member.

2. The row unit of claim 1, wherein the resilient member comprises a substantially circular member.

3. The row unit of claim 1, wherein the rotational velocity of the resilient member is determinative on the ground speed of the row unit such that a seed discharged will experience a net zero velocity when dropped in the furrow.

4. The row unit of claim 1, wherein the seed meter comprises a seed chute for receiving seed released from the seed disc and positioned adjacent an opening of the seed tube.

5. The row unit of claim 4, wherein the seed delivery system further comprises at least one trailing arm extending between the resilient member and the ground contact drive.

6. The row unit of claim 5, wherein the ground contact drive comprises at least one wheel that travels on the ground to obtain a ground speed.

7. The row unit of claim 6, wherein the seed delivery system further comprises at least one transfer member connecting the ground contact drive to the resilient member.

8. The row unit of claim 7, wherein the at least one transfer member comprises one or a combination of a belt, a chain, a fluid, a linkage, or a gear system.

9. The row unit of claim 1, wherein the resilient member is a wheel comprising foam or rubber.

10. The row unit of claim 9, wherein the resilient member is a wheel comprising a plurality of ribs and grooves.

11. The row unit of claim 1, further comprising first and second seed meters on the row unit and configured to dispense seed into a common seed tube.

11. The row unit of claim 1, wherein the contact drive is a wheel comprising steel.

12. The row unit of claim 1, wherein the contact drive is a wheel comprising rubber.

13. An agricultural planting implement including a plurality of row units, each of said row units having a planting rate and comprising:
at least one seed meter comprising a seed disc and a seed exit; and
a seed delivery system for transporting seed from the seed meter to a furrow in the ground, the seed delivery system comprising:
a seed tube operatively connected to the seed meter;
a resilient member positioned near a bottom of the seed tube for transporting seed at least partially between the seed tube and the resilient member to discharge the seed towards the furrow; and
a ground contact drive operatively connected to resilient member and configured to translate the ground speed of the row unit to a rotational velocity for the resilient member;
wherein said ground speed is configured to match the speed of the agricultural implement at a particular row unit such that the row units can experience variable ground speeds and corresponding planting rates.

14. The implement of claim 13, further comprising a second ground contact drive operatively connected to the at least one seed meter to determine the planting rate of the seed meter at a row unit of the implement.

15. The implement of claim 13, wherein the resilient member of the seed delivery system is a wheel connected to the ground contact drive via a transfer member.

16. The implement of claim 15, wherein the ground contact drive is a wheel pivotally connected to the seed tube via at least one trailing arm.

17. The implement of claim 16, wherein the transfer member connecting the resilient member to the ground contact drive wheel comprises one or a combination of a belt, a chain, a fluid, a linkage, or a gear system.

18. A seed delivery system for use with a row unit of an agricultural planting implement having a plurality of row units each with at least one seed meter for dispensing seed towards a furrow, the seed delivery system comprising:
a seed tube operatively connected to the seed meter;
a resilient member positioned near a bottom of the seed tube for transporting seed at least partially between the seed tube and the resilient member to discharge the seed towards the furrow; and
a ground contact drive operatively connected to resilient member and configured to translate the ground speed of the row unit to a rotational velocity for the resilient member.

19. The seed delivery system of claim 18, wherein the seed delivery system further comprises at least one transfer member connecting the ground contact drive to the resilient member.

20. The row unit of claim 19, wherein the at least one transfer member comprises one or a combination of a belt, a chain, a fluid, a linkage, or a gear system.
